(19) United States
(12) Patent Application Publication
(10) Pub. No.: US 2009/0015481 A1
(43) Pub. Date: Jan. 15, 2009

(54) MULTI-BAND EMBEDDED ANTENNA

(75) Inventors: Hsin-Tsung Wu, Taipei Hsien (TW); Kai Shih, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/775,069

(22) Filed: Jul. 9, 2007

(51) Int. Cl. H01Q 1/36; H01Q 9/06

(52) U.S. Cl. 343/700 MS

(57) ABSTRACT

A multi-band embedded antenna includes a flat antenna base with an upper edge, a lower edge, a left edge and a right edge therearound. The antenna base has a plow groove with a first plow groove extending downward from the upper edge and a second plow groove extending rightward from the bottom of the first plow groove, a first radiate portion adjacent to the left edge, a second radiate portion above the second plow groove. The first radiate portion has a gap placed at the lower left corner thereof, a radiate strip and a radiate crossband extending leftward from the top of the radiate strip. The second radiate portion has a slot parallel to the first plow groove, a signal feed point at the lower right corner thereof and a connecting portion extending downward from the right side thereof. The antenna base further includes a bending portion extending downward from the bottom of the radiate strip and then rightward to connect with the connecting portion.

### BACKGROUND OF THE INVENTION

1. Field of the Invention

The present invention relates to an antenna for radiating/receiving wireless signal, and more specifically to a multi-band embedded antenna operating over a wide bandwidth of frequency or over multiple frequency bands.

2. The Related Art

As the communication technology develops, the wireless data devices become popular and are required to be small and light. Thus, the antenna installed in the wireless data devices as a radiating/receiving wireless signal part is needed to be small. Meanwhile, increasing numbers of the users requires various frequency band of system to provide the data rates necessary for a new multimedia services.

In order to fulfill the customer's demand for wireless data services, wireless data devices such as mobile phones must provide a network not only supporting various content but also being a seamless system that customers can rely on anywhere and anytime.

Take the most popular Global System for Mobile Communications (GSM) systems for example, the GSM systems are standardized with specific frequency spectrums including 850 MHZ, 900 MHZ, 1800 MHZ, 1900 MHZ. The lower two frequency spectrums are the oldest and most commonly used throughout the world. The 1800 MHZ frequency range, or GSM 1800 (also called DCS 1800 and PCN (Personal Communication Network)) is found in an increasing number of countries throughout Europe and Asia. The 1900 MHZ range, or GSM 1900 (also called DCS 1900, PCS 1900, and PCS (Personal Communication Services)) is used in the United States and Canada for GSM.

A conventional multi-band embedded antenna 8 for radiating/receiving three frequency bands signal is shown in FIG. 1. The multi-band embedded antenna 8 includes a crooked antenna base 80 and a signal feed point 81 that divides the base 80 into two parts. A first radiate portion 82 is at one part of the base 80 with a groove bending back and forth and connecting with the signal feed point 81. An electrical resonance length of the groove is a half wavelength corresponding to a low frequency band such as GSM900 MHz band. So the first radiate portion 82 resonates with the low frequency band and receives or radiates the electromagnetic wave of GSM900 MHZ band. A second radiate portion 83 is at the other part of the base 80 with an U-shaped groove. The U-shaped groove obtains an electrical resonance length of a half wavelength corresponding to a high frequency band such as DCS1800 MHz band. So the second radiate portion 83 resonates with the high frequency band and receives or radiates the electromagnetic wave of DCS 1800 MHZ band. Meanwhile, the second radiate portion 83 receives or radiates the electromagnetic wave of the PCS1900 MHz band while the second radiate portion 83 coupling with the first radiate portion 82. Thus, the multi-band embedded antenna 8 can receive or radiate three electromagnetic waves of the GSM900 MHZ band, DCS1800 MHZ band and PCS1900 MHz band respectively. The electrical resonance length of the multi-band embedded antenna 8 are designed to equal a half wavelength or equal nearly a half wavelength of the electromagnetic waves. So the multi-band embedded antenna 8 is designed to a structure bending back and forth. The multi-band embedded antenna 8 located in the mobile phone has a large area.

### SUMMARY OF THE INVENTION

An object of the present invention is to provide a multi-band embedded antenna including a flat antenna base with an upper edge, a lower edge, a left edge and a right edge therearound. The antenna base has an L-shaped plow groove with a first plow groove extending downward from the upper edge and with a second plow groove extending rightward from the bottom of the first plow groove, a first radiate portion adjacent to the left edge, a second radiate portion above the second plow groove. The first radiate portion has a rectangular gap placed at the lower left corner thereof, a radiate strip formed adjacent to the first plow groove, and a radiate crossband above the gap extending leftward from the top of the radiate strip. The second radiate portion has a slot which is parallel to the first plow groove and connects with the second plow groove on the left thereof, a signal feed point at the lower right corner thereof, and a connecting portion extending downward from the right side thereof. The antenna base further comprises a bending portion extending downward from the bottom of the radiate strip and then rightward to connect with the connecting portion.

As above-mentioned, the first radiate portion receives or radiates the electromagnetic wave of low frequency band and the second radiate portion coupling with the first radiate portion receives or radiates two electromagnetic waves of high frequency band. With the help of the first radiate portion, the second radiate portion only needs to obtain an electrical resonance length that is smaller than a quarter wavelength corresponding to DCS1800 MHZ band for receiving or radiating two electromagnetic waves of high frequency band, therefore the multi-band embedded antenna has a small area with a simply first radiate portion and a simply second radiate portion, and mobile phones installing the multi-band embedded antenna 1 can therefore be simplified.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a conventional multi-band embedded antenna;

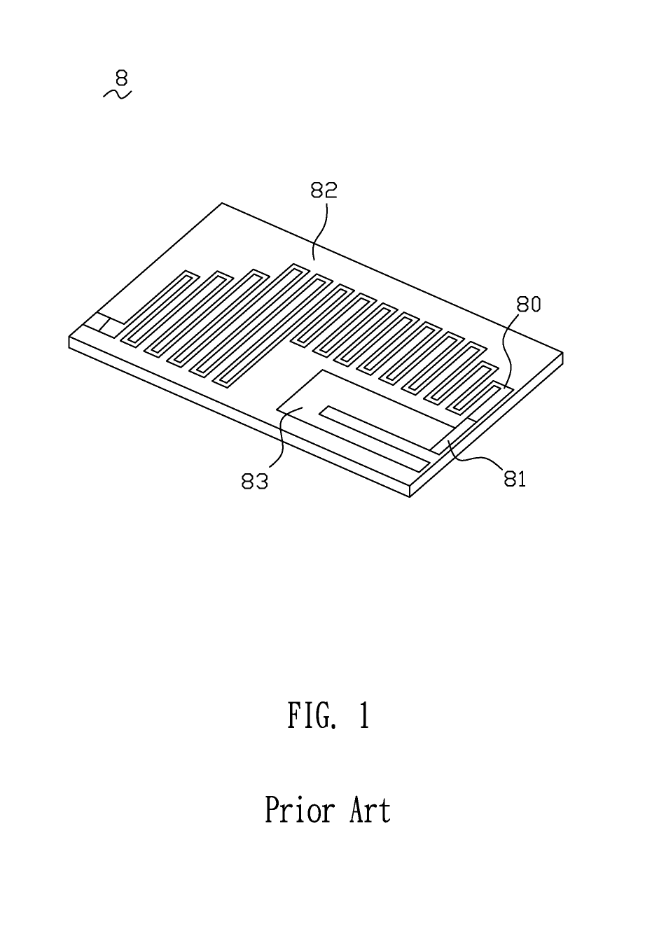

FIG. 2 is a perspective view of a multi-band embedded antenna in accordance with the present invention;

FIG. 3 is a perspective view of a multi-band embedded antenna placed on a bearing board in accordance with the present invention; and

FIG. 4 is a test chart recording for the multi-band embedded antenna of FIG. 2, showing Voltage Standing Wave Ratio (VSWR) as a function of frequency.

### DETAILED DESCRIPTION OF THE PREFERRED EMBODIMENT

The exact nature of this invention, as well as other objects and advantages thereof, will be readily apparent from consideration of the following specification relating to the accompanying drawings.

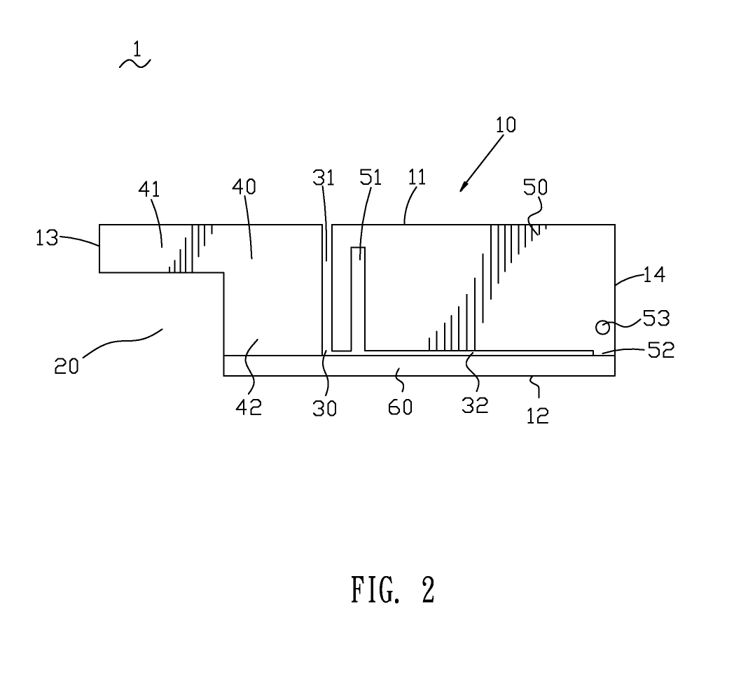

With reference to FIG. 2, a multi-band embedded antenna 1 adapted for receiving or radiating three wireless frequency bands signal according to the invention is shown. The multi-band embedded antenna 1 can be made of a square metal board in this embodiment or a metal foil of a PCB. The multi-band embedded antenna 1 includes a flat antenna base 10 with an upper edge 11, a lower edge 12, a left edge 13 and a right edge 14 therearound.

The antenna base 10 defines an L-shaped plow groove 30 with a first plow groove 31 extending downward from a portion of the upper edge 11 which is close to the left edge 13, with a second plow groove 32 extending rightward from the bottom of the first plow groove 31. The plow groove 30 divides the antenna base 10 into a first radiate portion 40 adjacent to the left edge 13 and a second radiate portion 50 above the second plow groove 32. The first radiate portion 40 defines a rectangular gap 20 placed at the lower left corner of the first radiate portion 40 and a radiate strip 42 formed adjacent to the first plow groove 31. A radiate crossband 41 above the gap 20 extends leftward from the top of the radiate strip 42. The first radiate portion 40 is a single-frequency antenna. The length of the radiate crossband 41 is bigger than the length of the radiate strip 42, and the width of the radiate strip 42 is bigger than the width of the radiate crossband 41.

The second radiate portion 50 defines a slot 51 on the left thereof. The slot 51 is parallel to the first plow groove 31 and connects with the second plow groove 32. The second radiate portion 50 defines a signal feed point 53 at the lower right corner thereof. A connecting portion 52 extending downward from the right side of the second radiate portion 50 is perpendicular to the lower edge 12. The second radiate portion 50 is also a single-frequency antenna. A bending portion 60 extends downward from the bottom of the radiate strip 42 and then rightward to connect with the connecting portion 52.

When the multi-band embedded antenna 1 is operated at wireless communication, a current is fed to the signal feed point 53. Then the current passes through the first radiate portion 40, so that the first radiate portion 40 obtains an electrical resonance length of a quarter wavelength corresponding to GSM900 MHz band. So the first radiate portion 40 resonates with the low frequency band and receives or radiates the electromagnetic wave of GSM900 MHZ band. Meanwhile, the current passes through the second radiate portion 50, so that the second radiate portion 50 couples with the first radiate portion 40 to obtain an electrical resonance length smaller than a quarter wavelength corresponding to DCS1800 MHZ band. So with the help of the first radiate portion 40, the second radiate portion 50 resonates with the high frequency band and receives or radiates the electromagnetic wave of DCS 1800 MHZ band and the electromagnetic wave of PCS 1900 MHz band.

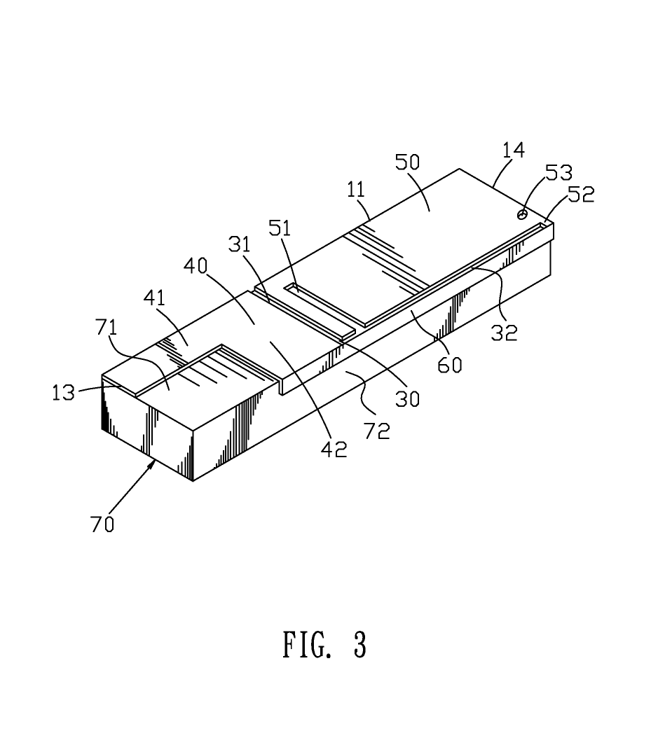

A bearing board 70 loading with the multi-band embedded antenna 1 is shown in FIG. 3. The bearing board 70 has a top surface 71 and a front surface 72. The multi-band embedded antenna 1 is overlaid about the top surface 71 with the upper edge 11 flush with the rear end of the top surface 71, with the right edge 14 flush with the right end of the bearing board 70, and with the left edge 13 flush with the left end of the bearing board 70. The bending portion 60 bends downward to cling to the front surface 72. Some other components such as blue tooth clips can be configured in the gap 20.

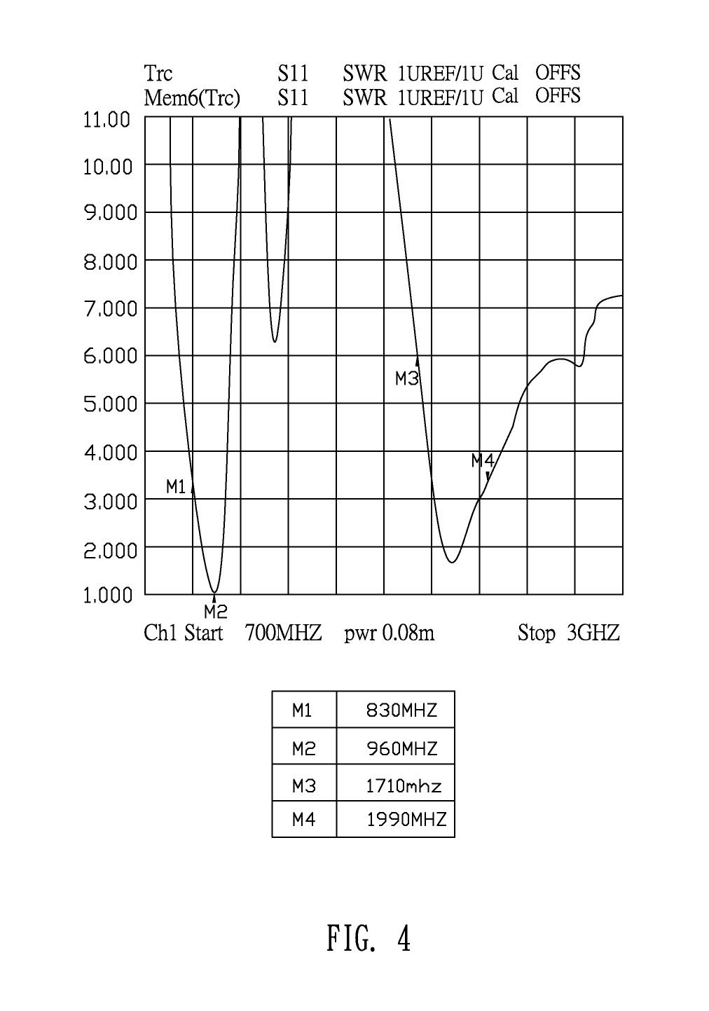

Please refer to FIG. 4, which shows a test chart recording of Voltage Standing Wave Ratio (VSWR) of the multi-band embedded antenna 1 as a function of frequency. Note of the VSWR drops below the desirable maximum value “M1” and above the desirable minimum value “M2” in the 830-960 MHz that covers the bandwidth of wireless communications under GSM900 standard. And note of the VSWR drops between the desirable maximum value “M3” and “M4” in the 1710-1990 MHz that covers the bandwidth of wireless communications under DCS 1800, PCS 1900 MHz standard.

According to the cooperation of the first radiate portion 40 and the second radiate portion 50 of the multi-band embedded antenna 1, the multi-band embedded antenna 1 can operate at wireless telecommunication bands including GSM900 MHz band, DCS1800 MHZ band and PCS1900 MHz band. Additionally, the multi-band embedded antenna 1 will obtain an appropriate plus via the bending portion 60 clung to the front surface 72.

As above-mentioned, the first radiate portion 40 receives or radiates the electromagnetic wave of GSM900 MHZ band. The second radiate portion 50 receives or radiates the electromagnetic wave of DCS 1800 MHZ band and GSM900 MHz band without obtaining an electrical resonance length of a quarter wavelength corresponding to high frequency band. So the multi-band embedded antenna 1 has a small area with a simply first radiate portion 40 and a simply second radiate portion 50, and mobile phones installing the multi-band embedded antenna 1 can therefore be simplified.

The foregoing disclosure and description of the invention are illustrated and explanatory thereof, and various changes in the size, shape, materials, and components as well as in the details of the illustrated construction may be made without the spirit of the invention.

What is claimed is:

1. A multi-band embedded antenna comprising:
a flat antenna base with an upper edge, a lower edge, a left edge and a right edge therearound;
a L-shaped plow groove with a first plow groove extending downward from the upper edge and with a second plow groove extending rightward from the bottom of the first plow groove;
a first radiate portion adjacent to the left edge having a gap placed at the lower left corner thereof, a radiate strip formed adjacent to the first plow groove, and a radiate crossband above the gap extending leftward from the top of the radiate strip;
a second radiate portion above the second plow groove having a slot which is parallel to the first plow groove and connects with the second plow groove on the left thereof, a signal feed point at the lower right corner thereof, and a connecting portion extending downward from the right side thereof; and
a bending portion extending downward from the bottom of the radiate strip and then rightward to connect with the connecting portion.

2. The multi-band embedded antenna as claimed in claim 1, wherein the length of the radiate crossband is bigger than the length of the radiate strip, and the width of the radiate strip is bigger than the width of the radiate crossband.

3. The multi-band embedded antenna as claimed in claim 1, wherein the connecting portion is perpendicular to the lower edge.

4. The multi-band embedded antenna as claimed in claim 1, wherein the first radiate portion has an electrical resonance length of a quarter wavelength corresponding to GSM900 MHz band.

5. The multi-band embedded antenna as claimed in claim 1, wherein the second radiate portion has an electrical resonance length smaller than a quarter wavelength corresponding to DCS 1800 MHZ band.
